(19) United States
(12) Patent Application Publication
(10) Pub. No.: US 2023/0376492 A1
(43) Pub. Date: Nov. 23, 2023

(54) ATHLETE DATA AGGREGATION SYSTEM

(71) Applicant: The Power Player Inc., Buffalo, NY (US)

(72) Inventors: David E. MASON, Barrington, IL (US); Kevin KRUEGER, Bay Village, OH (US); Steven M. KULL, Hamburg, NY (US); Brendan J. STAUB, Grand Island, NY (US); Joseph P. GANNON, Buffalo, NY (US)

(21) Appl. No.: 18/186,857

(22) Filed: Mar. 20, 2023

Related U.S. Application Data
(63) Continuation of application No. 17/447,250, filed on Sep. 9, 2021, now abandoned.
Application No. 17/447,250 is a continuation of application No. 15/169,607, filed on May 31, 2016, now abandoned.
(60) Provisional application No. 62/168,778, filed on May 30, 2015.

(51) Int. Cl. G06F 16/2457; G06Q 10/0639; G06Q 10/0633; G06Q 10/067; G01D 9/00; G06F 16/242; G06F 16/2455

(52) U.S. Cl. CPC G06F 16/24578; G06Q 10/0639; G06Q 10/0633; G06Q 10/067; G01D 9/005; G06F 16/244; G06F 16/24556; G06F 16/24575

(57) ABSTRACT

An athlete data aggregation system for is a single point for collection, aggregation, visualization and selective distribution of quantitative and qualitative athlete related data. The system includes facilitating the plurality of athletes and a plurality of stake-holders to enter qualitative and quantitative athlete related information on a web-based platform, collecting the qualitative and quantitative athlete related information, analyzing the qualitative and quantitative athlete related information, aggregating and visualizing the qualitative and quantitative athlete related information, and selectively distributing the qualitative and quantitative athlete related information to the plurality of athletes and the plurality of stake-holders. The system also provides development tools for athletes, assessment tools for athletes and keeps the athletes engaged not only with each other but also with various stake-holders.

### CROSS-REFERENCE TO RELATED APPLICATIONS

This application is a continuation of U.S. patent application Ser. No. 17/447,250, filed Sep. 9, 2021, which application is a continuation of U.S. patent application Ser. No. 15/169,607, filed May 31, 2016, which application claims the benefit under 35 U.S.C. § 119(e) of U.S. Provisional Patent Application Ser. No. 62/168,778, filed May 30, 2015, the disclosures of which are herein incorporated by reference.

### TECHNICAL FIELD

The present invention relates generally to a data aggregation system, and more particularly, to the data aggregation system for athletes and associated stake-holders.

### BACKGROUND

During the last several years, the advancements of technology have had a tremendous impact on our lives. There are various real life scenarios where use of internet, electronics and communication devices such as personal computers, sensing networks and devices, hand-held personal organizers and computerized automotive controls have changed one's daily life. However, there are very few instances where these technological advancements are being efficiently used in sports industry, especially for the athletes.

More often than not, an athlete has to make his/her professional decisions based on his personal assessment on various past events. These decisions may turn out to be wrong as these decisions are just based on personal assessment and memory of past events. For example, the athlete do not have a aggregated data for the matches played by him at different stages of his career, his performances in various games, his personal physical attributes at different stages of his career, and so on. Further, the athlete does not have a data of various coaches he has played under. So, he cannot make a judgment about the coach who was effective in improving a particular skill at a particular point of time. In addition, the athlete does not have any data which he can analyze. So, in absence of any data, the athlete usually is not able to improve himself and improve his performance. Moreover, the athlete does not have any data related to other athletes by which he can take appropriate decisions. For example, the athlete does not have the data of another player who has honed his skill playing under certain different conditions at a particular point of time. The athlete receives this information based on knowledge of his known person and/or from people of his fraternity.

In addition, various stake-holders like sports governing bodies, club owners, coaches, scouts, personal trainers, selection team, and the like which play an important role in shaping an athlete's career do not have access to the data on which they can rely on to take decisions. For example, for selecting a team, a selector may like to know the past achievements of the athlete, the coaches under which the athlete has been trained, his recent performances, his ability to play under different circumstances and so on. Similarly, a club owner may like to know some other facts which may help him in making a sound judgment not only about the athlete but also for his own club. The stake-holders do not have a single point of viewing and analyzing qualitative and quantitative athlete related data.

In light of the above stated discussion, there is a need for a method and system which provide a single point for collection, aggregation, visualization and selective distribution of the quantitative and the qualitative athlete related data.

### SUMMARY

The present invention aims to overcome the above mentioned limitations and other problems associated with the prior art.

The present disclosure provides an athlete data aggregation system for a plurality of athletes. The data aggregation system is a single point for collection, aggregation, visualization and selective distribution of quantitative and the qualitative athlete related data. The data aggregation system includes facilitating the plurality of athletes and a plurality of stake-holders to enter qualitative and quantitative athlete related information on a web-based platform, collecting the qualitative and quantitative athlete related information, analyzing the qualitative and quantitative athlete related information, aggregating and visualizing the qualitative and quantitative athlete related information and selectively distributing the qualitative and quantitative athlete related information to the plurality of athletes and the plurality of stake-holders. The athlete data aggregation system provides development tools for athletes, assessment tools for athletes and keeps the athletes engaged not only with each other but also with various stake-holders.

In an embodiment of the present disclosure, the athlete data aggregation system enables the plurality of stake-holders to provide specific comments and suggestions to the plurality of athletes.

In an embodiment of the present disclosure, the plurality of stake-holders include a plurality of coaches, a plurality of club managers, a plurality of governing bodies, a plurality of scouts, a plurality of trainers, a plurality of nutritionists, and the guardians of the respective plurality of athletes.

In an embodiment of the present disclosure, the athlete data aggregation system provides a chance to the plurality of athletes to earn profits from his performance.

In an embodiment of the present disclosure, the athlete data aggregation system provides motivation and creates community and connection for the plurality of athletes.

In an embodiment of the present disclosure, the athlete data aggregation system provides a feedback to the plurality of athletes based on performance in different matches.

In an embodiment of the present disclosure, the athlete data aggregation system provides parameters for measuring strengths, weakness and progress of each of the plurality of athletes.

### BRIEF DESCRIPTION OF THE FIGURES

Having thus described the invention in general terms, reference will now be made to the accompanying drawings, which are not necessarily drawn to scale, and wherein:

FIG. 1 illustrates an athlete data aggregation system, in accordance with various embodiments of the present disclosure;

FIG. 2 illustrates a block diagram of the athlete data aggregation system, in accordance with various embodiments of the present disclosure;

FIG. 3A, FIG. 3B, FIG. 3C, FIG. 3D, FIG. 3E, FIG. 3F and FIG. 3G illustrate example snapshots of a user interface of the data aggregation system, in accordance with various embodiments of the present disclosure; and

FIG. 4 provides a brief general description of a suitable computing environment in which the disclosure can be implemented.

### DETAILED DESCRIPTION

The exemplary embodiments described herein for illustrative purposes are subject to many variations in structure and design. It should be emphasize, however, that the present invention is not limited to method for erasing data from a volatile memory. It is understood that various omissions and substitutions of equivalents are contemplated as circumstances may suggest or render expedient, but these are intended to cover the application or implementation without departing from the spirit or scope of the present invention.

The terms “a” and “an” herein do not denote a limitation of quantity, but rather denote the presence of at least one of the referenced item.

The terms “having”, “comprising”, “including”, and variations thereof signify the presence of a component.

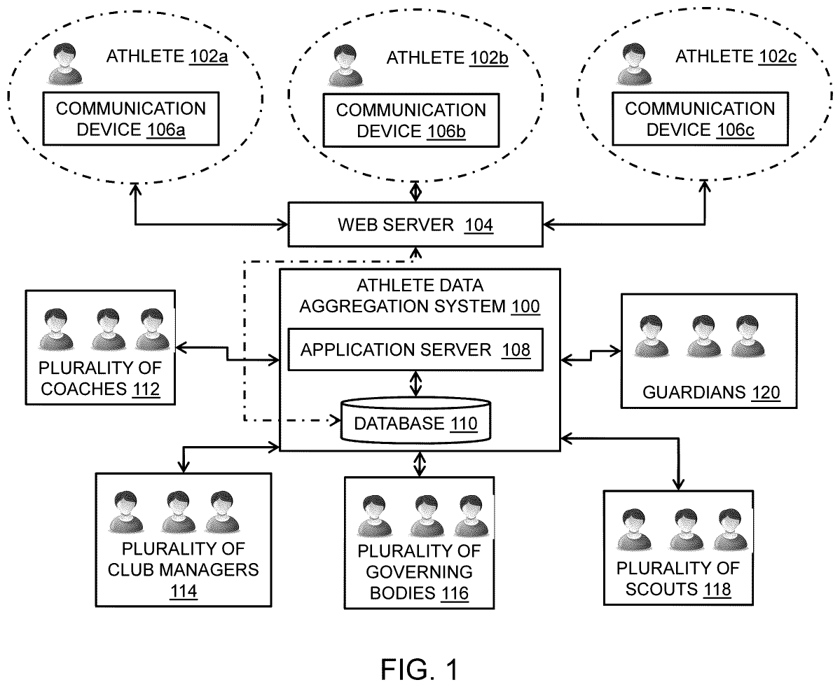

FIG. 1 illustrates an athlete data aggregation system 100, in accordance with various embodiments of the present disclosure. The athlete data aggregation system 100 is a single point for collection, aggregation, visualization and selective distribution of the quantitative and the qualitative athlete related data. The aggregation, visualization and selective distribution of the quantitative and the qualitative athlete related data empowers multiple stake-holders to take informed decisions at different stages. In addition, the athlete data aggregation system 100 provides development tools for athletes, assessment tools for athletes and keeps the athletes engaged not only with each other but also with various stake-holders.

As shown in FIG. 1, an athlete 102a, an athlete 102b and an athlete 102c interacts with the athlete data aggregation system 100 through a web server 104. The athlete 102a is associated with a communication device 106a, the athlete 102b is associated with a communication device 106b and the athlete 102c is associated with a communication device 106c. In an embodiment of the present disclosure, each of the communication devices 106a-c is a portable device. Examples of the communication devices 106a-c include but may not be limited to mobile phones, tablets, laptops and the like. Further, each of the communication device 106a-c is associated with the web server 104. In simpler terms, each of the athletes 102a-c communicates with the web server 104 through the corresponding communication devices 106a-c.

In addition, a plurality of stake-holders 112-120 is associated with the athlete data aggregation system 100. The plurality of stake-holders 112-120 include a plurality of coaches 112, a plurality of club managers 114, a plurality of governing bodies 116, a plurality of scouts 118 and guardians 120. Each of the plurality of stake-holders 112-120 interacts with the athlete data aggregation system 100 with a corresponding communication device. The athlete data aggregation system 100 includes an application server 108 and a database 110.

In an embodiment of the present disclosure, the athlete data aggregation system 100 enables the athletes 102a-c to register on a web-based platform and/or application supported and/or maintained by the athlete data aggregation system 100 through the corresponding communication devices 106a-c. Further, the athlete data aggregation system 100 enables the plurality of stake-holders 112-120 to register on the web-based platform and/or application. In an embodiment of the present disclosure, each of the athletes 102a-c accesses the web-based platform and/or application through the web server 104. Further, the application server 108 runs the web-based platform and/or application.

Further, the athlete data aggregation system 100 enables the athletes 102a-c to enter the quantitative and qualitative information on the web-based platform and/or application. The athlete data aggregation system 100 performs a set of operations based on the quantitative and qualitative information entered by the athletes 102a-c. In an embodiment of the present disclosure, the athlete data aggregation system 100 enables an athlete (say athlete 102a) to enter the quantitative and qualitative information without registering on the web-based platform and/or application. In another embodiment of the present disclosure, the athlete data aggregation system 100 enables the athlete 102a to enter the quantitative and qualitative information by registering on the web-based platform and/or application.

On the same lines, the athlete data aggregation system 100 enables the stake-holders 112-120 (the plurality of coaches 112, the plurality of club managers 114, the plurality of governing bodies 116, the plurality of scouts 118 and the guardians 120) to enter the quantitative and qualitative information of the athletes 102a-c on the web-based platform and/or application. In an embodiment of the present disclosure, the athlete data aggregation system 100 performs a set of operations based on the quantitative and qualitative information entered by the athletes 102a-c. In another embodiment of the present disclosure, the athlete data aggregation system 100 performs a set of operations based on the quantitative and qualitative information entered by the athletes 102a-c and by the stake-holders 112-120. It may be noted that the data aggregation system 100 will allow a coach of the plurality of coaches 112 to enter the information of the athletes 102a-c based on a past or current association. For example, the coach may have coached the athlete 102c. The coach can enter the information corresponding to the athlete 102c.

Further, the athlete data aggregation system 100 facilitates storing the information and results of the set of operations in the database 110. Moreover, the stake-holders 112-120 may have access to all or subset of the quantitative and qualitative information of each of the athletes 102a-c and results of the set of operations performed on the quantitative and qualitative information pertaining to the athletes 102a-c. In an embodiment of the present disclosure, the quantitative and qualitative information may be aggregated and selective distributed to the stake-holders 112-120 (described later in the application). In an embodiment of the present disclosure, the athlete data aggregation system 100 charges an amount from the athletes 102a-c and the plurality of stake-holders 112-120 for establishing and maintaining the account on the web-based platform. The amount can be payable by at least one of following means including online banking, using credit cards, using debit cards and the like. Furthermore, the athlete data aggregation system 100 generates an id for each of the athletes 102a-c and each of the stake-holders 112-120 after receiving the payment from each of the athletes 102a-c. The id enables the athletes 102a-c to access the web-based platform. Furthermore, it may be noted that FIG. 1 is shown to include the stake-holders 112-120 which include the plurality of coaches 112, the plurality of club managers 114, the plurality of governing bodies 116, the plurality of scouts 118 and the guardians 120; however, those skilled in the art would appreciate that there can be lesser or more number of stake-holders. Similarly, it may be noted that in FIG. 1, three athletes (102a, 102b and 102c) are shown to interact with the athlete data aggregation system 100; however, those skilled in the art would appreciate that more or lesser number of athletes can interact with the athlete data aggregation system 100.

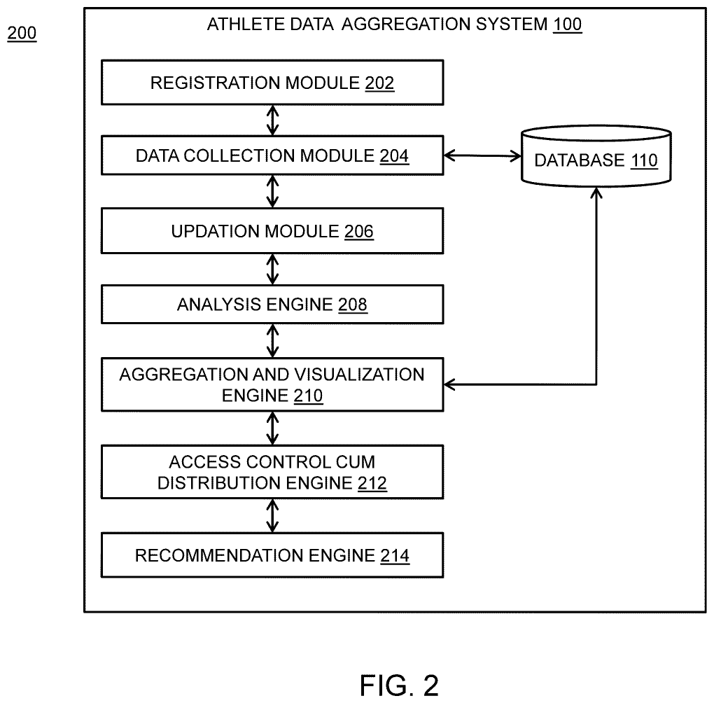

FIG. 2 illustrates a block diagram 200 of the athlete data aggregation system 100, in accordance with various embodiments of the present disclosure. It may be noted that to explain the system elements of FIG. 2, references will be made to the system elements of the FIG. 1. The block diagram 200 of the athlete data aggregation system 100 includes a registration module 202, a data collection module 204, an update module 206, an analysis engine 208, an aggregation and visualization engine 210, an access control cum distribution engine 212, and a recommendation engine 214. Further, the data collection module 204 is associated with the database 110.

The registration module 202 enables the registration of the athletes 102a-c on the web-based platform and/or application. Further, the registration module 202 enables registration of each of the stake-holders 112-120 on the web-based platform and/or application. In an embodiment of the present disclosure, the registration module 202 enables the athletes 102a-c and the stake-holders 112-120 to set up an account on the web-based platform. For setting the account, the athletes 102a-c and the plurality of the stake-holders 112-120 enters a set of information on the web-based platform and/or application. The information includes but may not be limited to personal information. The personal information includes a first name, a last name, an email id, a password, a phone number, an address, a city name, a state name, a country name, academic information, family background and the like. The athletes 102a-c and the plurality of the stake-holders 112-120 registers on the athlete data aggregation system 100 by entering the personal information on the web-based platform.

Moreover, the data collection module 204 enables each of the athletes 102a-c to enter profile information including a quantitative data and a qualitative data. As mentioned above, the quantitative data includes input metrics, uploaded audios/videos and the like (described later). The qualitative data includes input ratings, points, comments, messages and the like (described later). In an embodiment of the present disclosure, the athletes 102a-c enters sports related information including types of sports played, position in each of the sports played, names of previous and current coaches, names of previous clubs each of the athletes 102a-c has represented, names of current clubs each of the athletes 102a-c is representing, diet plans, practice plans, levels at which each of the athletes 102a-c has played (for example, club level, international tournaments and the like), skills related to the sports played and the like.

In an embodiment of the present disclosure, each of the athletes 102a-c may play and enter data related to more than one sport. It may be noted that the scope of the invention is not limited by entering the above stated information as profile information; those skilled in the art would appreciate that each of the athletes 102a-c may enter other related information as well. In an embodiment of the present disclosure, the guardians 120 may enter the above stated information on behalf of their children (the athletes 102a-c) on the web-based platform. In another embodiment, the plurality of coaches 112 may enter the above stated information or other information pertaining to the athletes 102a-c on the web-based platform.

For example, an athlete X1 plays ice hockey for a club Y1. The athlete X1 enters the names of the previous and current coaches of the team, his diet plan (for example, milk, fruits and other fiber foods) during his matches. Further, he practice 12 hours daily during time of matches and even enters data related to his skills, say, puck skills, skating and the like. Similarly, another athlete X2 plays basketball for a club Y2. The athlete X2 enters the names of the previous and current coaches of the team, his diet plan (for example, milk, fruits and other fiber foods) during his matches. Further, he practice 10 hours daily during time of matches and enters data related to his skills, say, dribbling skills, shooting skills and the like.

In another embodiment, each of the athletes 102a-c enters information including coachability, attitude, work ethic, communication skills, listening skills, grasping power of concepts, rapport with coaches and team mates, competitiveness, mental toughness, athleticism, sports sense, on-field exercise routine, off-field exercise routine, calendars/schedules and the like. It may be noted that the scope of the invention is not limited by entering the above stated information such as the profile information; those skilled in the art would appreciate that each of the athletes 102a-c may enter other related information as well. In an embodiment of the present disclosure, the guardians 120 may enter the above stated information on behalf of their children (the athletes 102a-c) or any other pertinent information on the web-based platform. In another embodiment, the plurality of coaches 112 may enter the above stated information or any other information of the athletes 102a-c or on behalf of the athletes 102a-c on the web-based platform.

For example, the athlete X1 enters a list of his upcoming matches (say, in a period of 4 months), information related to time devoted for exercises, say, a total of 3 hours daily for stretching, running, jogging, leg movements and the like. Similarly, the athlete X2 enters a list of his upcoming matches (say, in a period of 5 months), information related to time devoted for exercises, say, a total of 6 hours daily for stretching, running, jogging, leg movements, hand movements and the like.

In yet another embodiment, each of the athletes 102a-c may upload match and demonstration images, match audios and videos, demonstration audios and videos, drill schematics, article links, and the like. It may be noted that the scope of the invention is not limited by entering the above stated information as the profile information; those skilled in the art would appreciate that each of the athletes 102a-c may enter other related information as well. For example, the athletes X1 and X2 upload their videos when they scored a goal and a basket respectively. In an embodiment of the present disclosure, the guardians 120 may upload the match and demonstration images, the match audios and videos, the demonstration audios and videos, the drill schematics, the article links, and the like on behalf of their children (the athletes 102a-c) on the web-based platform. In another embodiment, the plurality of coaches 112 may upload the audios and videos on behalf of the athletes 102a-c on the web-based platform.

In an embodiment of the present disclosure, each of the athletes 102a-c may give ratings and/or points to himself based upon a performance in a match or a couple of matches in a tournament. In another embodiment, the plurality of coaches 112 coaching the athletes 102a-c may give the ratings, the points, the comments, the messages to each of the athletes 102a-c based upon his performance in a match or a couple of matches in a tournament. In yet another embodiment, the plurality of stake-holders 112-120 (the plurality of club managers 114, the plurality of governing bodies 116, the plurality of scouts 118 and the guardians 120) may give the ratings, the points, the comments, the messages to each of the athletes 102a-c based upon his performance in a match or a couple of matches in a tournament. In yet another embodiment, the athletes 102a-c may/may not rate a coach of the plurality of coaches 112 based on a performance of the team under his role and guidance. In yet another embodiment, the guardians 120 may provide the comments to their children (the athletes 102a-c) regarding their performance in the game.

Further, the guardians 120 may provide feedback regarding each of the plurality of coaches 112. In an embodiment of the present disclosure, the guardians 120 may give comments to the plurality of coaches 112. For example, a guardian G1 thinks that under a coach C1, the performance of their child (say, the athlete 102a) has gone below a suitable mark, and thus rates the coach C1 very low. On the other hand, the same guardian G1 thinks that under a coach C2, the performance of their child (say, the athlete 102a) has further increased, and thus rates the coach C2 very high. In yet another embodiment, the guardians 120 may file a complaint against any coach of the plurality of coaches 112. In this case, the plurality of club managers 114 and the plurality of governing bodies 116 can communicate and try to resolve the case.

Further, in an embodiment of the present disclosure, the athletes 102a-c and the plurality of stake-holders 112-120 may give ratings by simply writing one or more values. In another embodiment, the athletes 102a-c and the plurality of stake-holders 112-120 may give ratings by choosing from a drop down list (say, a list representing poor, average, good, very good and excellent). In yet another embodiment, the athletes 102a-c and the plurality of stake-holders 112-120 may give the ratings by using one or more scales. The one or more scales may feature different skills of the athletes 102a-c. In yet another embodiment, the guardians 120 may give comments to the athletes 102a-c based on their performances. It may be noted that various rating tools (described above) are provided to rate the athletes 102a-c based on his skills; however those skilled in the art would appreciate that more rating tools may be provided to rate the athletes 102a-c.

In an embodiment of the present disclosure, each of the athletes 102a-c may have the permissions to view each other's profile. Further, each of the athletes 102a-c may provide the ratings and the comments to each other.

Further, the data collection module 204 collects the information and the data described above and stores it in the database 110. Further, the data collection module 204 collects and maintains a repository of the collected information in the database 110. In an embodiment of the present disclosure, each of the athletes 102a-c may redeem the points obtained/earned by them. In an embodiment of the present disclosure, the data collection module 204 collects the quantitative and qualitative information from third party sources such as web, third party database, or any other source.

Further, the update module 206 enables an automatic update of the stored information in the database 110 whenever any additional information is entered by each of the athletes 102a-c and the stake-holders 112-120. In simpler terms, with each additional information entered by each of the athletes 102a-c and the stake-holders 112-120, the database 110 gets updated at regular intervals of time. In an embodiment of the present disclosure, previously stored records are also maintained for future references. In other words, the database 110 is dynamic and updates on periodic basis.

For example, the athlete X1 has updated his new address and phone number on the web-based platform, the same gets updated in the database 110 as well. In another example, the athlete X2 uploads a video showing number of baskets shot by him in his last match, or enters a change in the diet plan and the practice plan on the web-based platform. The update module 206 updates these changes in the database 110 as well.

The analysis engine 208 analyzes both the quantitative and the qualitative data uploaded and/or entered by each of the athletes 102a-c. In an embodiment of the present disclosure, the analysis engine 208 analyzes the performance of each of the athletes 102a-c in a period of time, say, in a year, last five matches, last half an hour of the game and the like. In another embodiment, the analysis engine 208 analyzes performance of the athletes 102a-c under a specific coach and performance of the athletes 102a-c affected due to changes in the diet plan, practice plan and the like.

Continuing with the above stated example, the analysis engine 208 analyzes that athlete X1 has played better under guidance of his new coach ‘A’ rather than his previous coach ‘B’. Further, the analysis engine 208 analyzes that the performance of the athlete X1 has improved in last 3 months by changing his diet plan, while the performance of the athlete X2 has degraded in last 3 months by changing his exercise plan. Further, the analysis engine 208 analyzes that the performance of the athlete X1 in last half an hour of the game has improved by adopting a better fitness plan and a cool-calm strategy.

The aggregation and visualization engine 210 aggregates the analyzed information at one place. The analyzed information includes analysis of both the quantitative and the qualitative data. Further, the aggregation and visualization engine 210 stores the aggregated information in the database 110. The aggregated information includes a collective data that influences the performance of the athletes 102a-c. For example, a data (say, a change in diet plans, a change in the exercise plans and the like) representing a positive impact on the performance of the athlete X1 is aggregated at a place and a data that leads to a negative impact on the performance of the athlete X1 is aggregated at another place. Similarly, a data (say, a change in diet plans, and the like) representing a positive impact on the performance of the athlete X2 is aggregated at a place and a data (say, the change in the exercise plans) that leads to a negative impact on the performance of the athlete X2 is aggregated at another place.

In an embodiment of the present disclosure, the aggregation and visualization engine 210 aggregates performance of the athletes 102a-c over a period of time, say a month, a year, last 5 matches played and the like. In another embodiment, the aggregation and visualization engine 210 aggregates performance of the athletes 102a-c under guidance of a coach and the plurality of coaches 112.

Further, the aggregation and visualization engine 210 generates and/or maintains pictorial representations and reports based on the analyzed and the aggregated information. The analyzed and the aggregated information can be pictorially represented as mountains, spiders, graphs, pie charts and the like. In an embodiment of the present disclosure, the pictorial representation illustrates the performance of the athletes 102a-c in a month, year or in last five matches. In another embodiment, the pictorial representation illustrates the performance of the athletes 102a-c in a game/sport. In yet another embodiment, the pictorial representation illustrates the performance of the athletes 102a-c in one or more games/sports. In yet another embodiment, the pictorial representation illustrates different skills of the athletes 102a-c in a match. In yet another embodiment, the pictorial representation illustrates different skills of the athletes 102a-c in a couple of matches.

Further, the pictorial representations may help the athletes 102a-c and the plurality of stake-holders 112-120 to further give the ratings, the comments, the points and the like.

In an embodiment of the present disclosure, the access control cum distribution engine 212 enables displaying of a set of the quantitative and qualitative information, the analyzed quantitative and qualitative information and the aggregated quantitative and qualitative information to each of the plurality of stake-holders 112-120. For example, the guardians 120 will be able to view one set of quantitative and qualitative information, the analyzed quantitative and qualitative information and the aggregated quantitative and qualitative information of the athlete 102a. The coaches 112 will be able to view another set of quantitative and qualitative information, the analyzed quantitative and qualitative information and the aggregated quantitative and qualitative information. In an embodiment of the present disclosure, each of the athletes 102a-c will be able to view a sub-set of the quantitative and qualitative information, the analyzed quantitative and qualitative information and the aggregated quantitative and qualitative information. For example, the athlete 102a may be able to view the ratings provided by his coach but may not be able to view the comments made by the selection committee.

In an embodiment of the present disclosure, an administrator of the athlete data aggregation system 100 sets the policies and permission for accessing the information for each of the athletes 102a-c and the plurality of stake-holders 112-120. In another embodiment, the access control cum distribution engine 212 enables each of the athletes 102a-c to restrict displaying and accessing of the set of information, the profile information, the analyzed and the aggregated information to the plurality of stake-holders 112-120. In yet another embodiment, the access control cum distribution engine 212 enables each of the athletes 102a-c to restrict and/or display set of quantitative and qualitative information, the analyzed quantitative and qualitative information and the aggregated quantitative and qualitative information to the plurality of stake-holders 112-120.

In an embodiment of the present disclosure, the access control cum distribution engine 212 enables each of the athletes 102a-c to set a privacy of their respective accounts. In an embodiment of the present disclosure, the recommendation engine 214 recommends each of the athletes 102a-c to improve specific skills, say, puck skills, skating skills (for the athlete X1) or to follow a specific practice plan, diet plan and the like. In another embodiment of the present disclosure, the recommendation engine 214 recommends the guardians 120 of each of the athletes 102a-c to change and/or give a specific diet to the corresponding athlete of the athletes 102a-c for their better performance. In yet another embodiment of the present disclosure, the recommendation engine 214 recommends the plurality of coaches 112 to follow a specific plan for the athletes 102a-c for their better performance.

In yet another embodiment of the present disclosure, the recommendation engine 214 recommends the plurality of governing bodies 116 and the plurality of club managers 114 to rank each of the athletes 102a-c based on the performance analyzed with the help of the pictorial representations. The recommendations are provided based on the analyzed information, the aggregated information, and the pictorial representations. More specifically, the recommendation engine 214 distributes the quantitative data, the qualitative data, the visualized reports, the pictorial representations and the like to the athletes 102a-c, and the plurality of stake-holders 112-120. Moreover, the recommendations prove to be useful for the plurality of governing bodies 116 and the plurality of club managers 114 during time of selection of the athletes 102a-c for one or more tournaments and leagues.

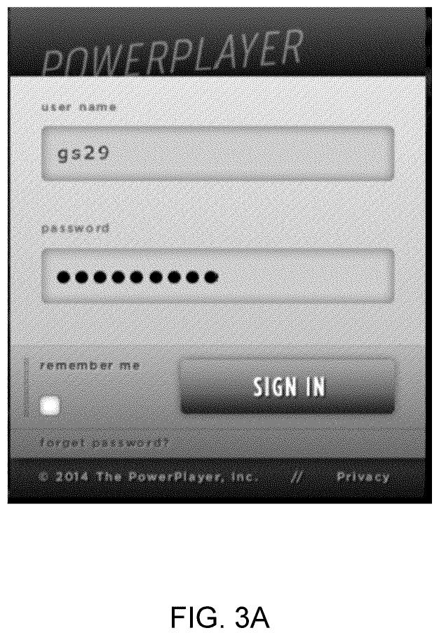

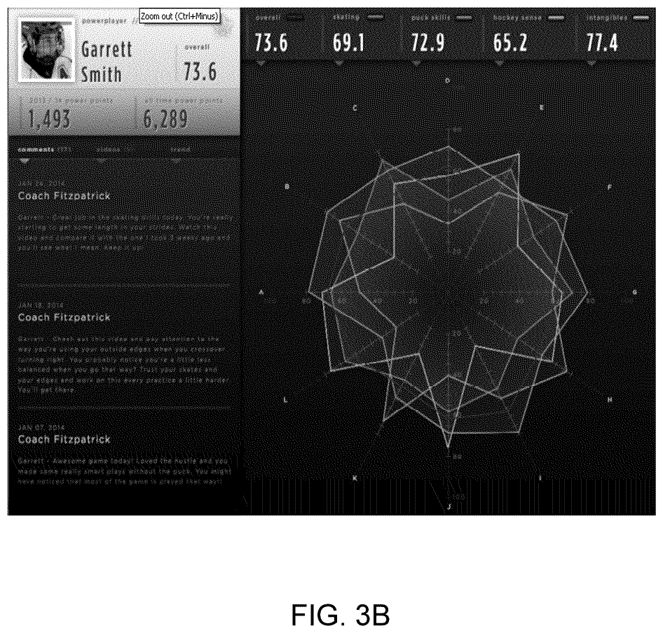

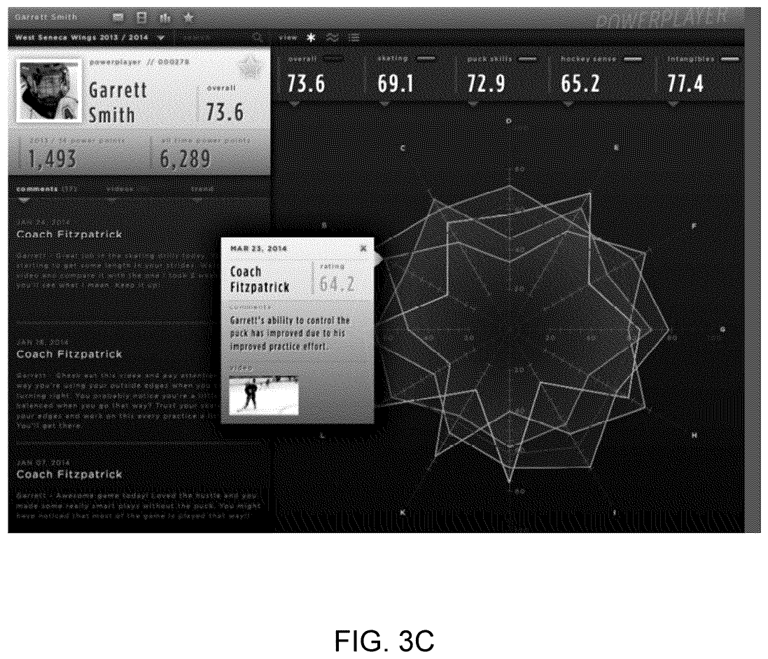

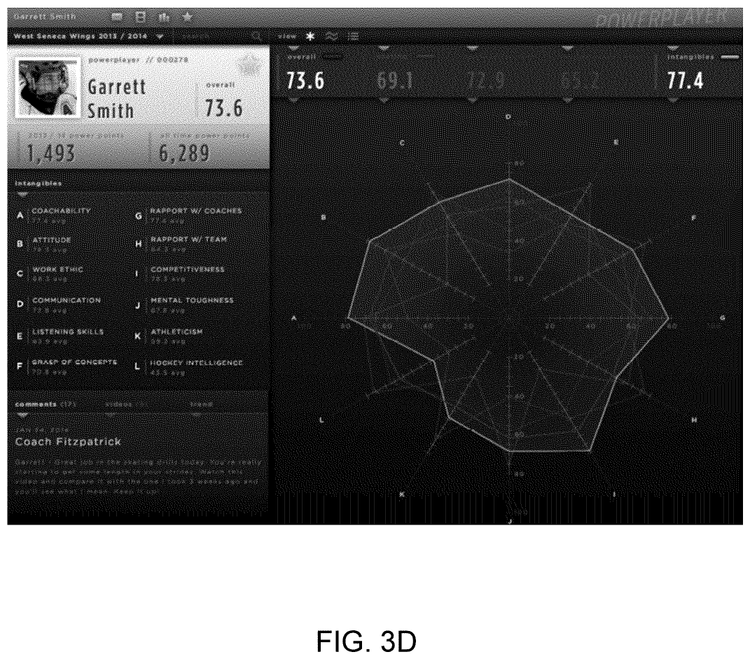

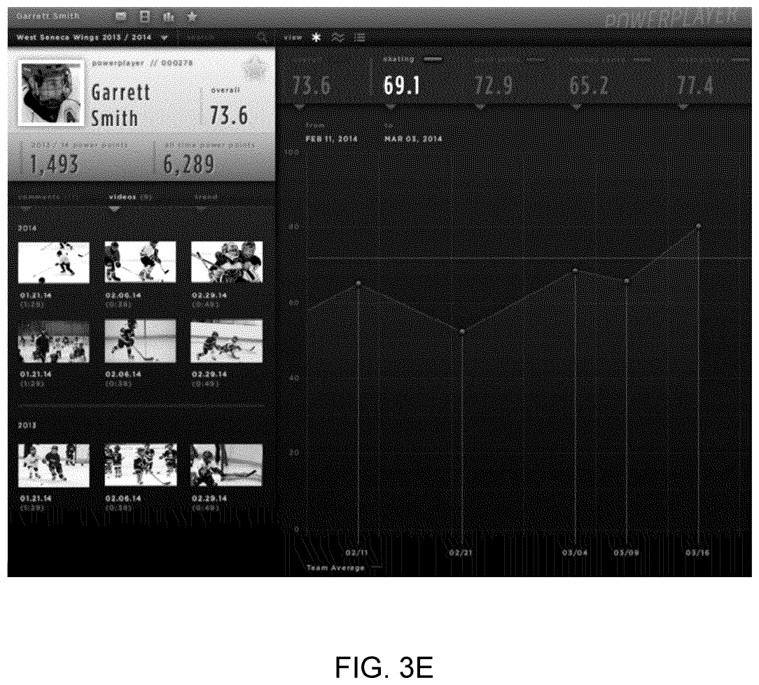

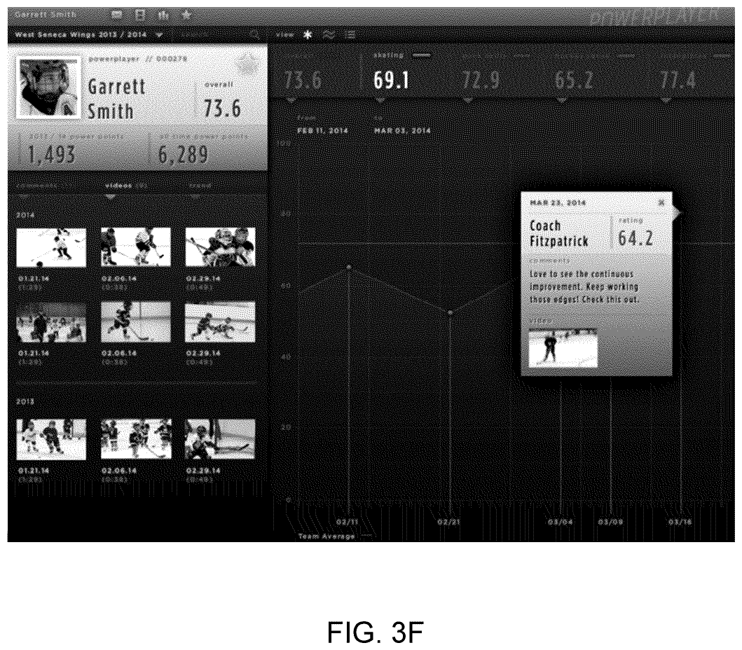

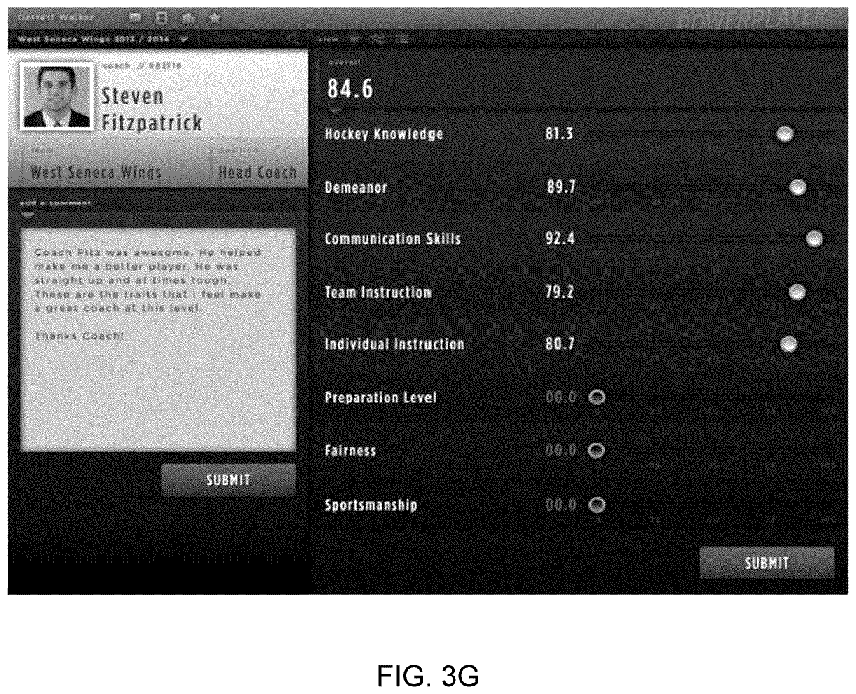

FIG. 3A, FIG. 3B, FIG. 3C, FIG. 3D, FIG. 3E, FIG. 3F and FIG. 3G illustrate example snapshots of a user interface of the athlete data aggregation system 100 that enables collection, aggregation, visualization and selective distribution of the quantitative and the qualitative athlete related data, in accordance with various embodiments of the present disclosure. It may be noted that the snapshots are for illustrative purpose only and there can be different designs, methods and systems of the user interface which enable the data collection, aggregation, visualization and selective distribution of the quantitative and the qualitative athlete related data. FIG. 3A illustrates a snapshot of a sample login screen for each of the athletes 102a-c. In an example, each of the athletes 102a-c needs to specify his corresponding user name and password to access their corresponding accounts on the web-based platform. FIG. 3B illustrates a snapshot of the sample profile of the athletes 102a-c and a pictorial representation (the spider) showing ratings of an athlete (say the athlete 102a). The spider demonstrates an overall ratings of the athlete 102a, ratings of his skating skills, puck skills, hockey sense and intangibles. Moreover, FIG. 3B shows the comments provided to the athlete 102 by his coach. FIG. 3C illustrates the profile of the athlete 102a, the comment and the rating provided to the athlete 102a by a coach based on a match video. The comment and the rating specify that the performance of the athlete 102a (specifically the puck skills) improved due to his greater practice efforts. Further, FIG. 3C shows the sample spider that describes the ratings of the athlete 102a. The spider demonstrates the overall ratings of the athlete 102a, the ratings of his skating skills, the puck skills, the hockey sense and the intangibles. FIG. 3D illustrates the sample profile of the athlete 102a including the ratings and/or averages provided to the athlete 102a corresponding to the coach ability, the attitude, the work ethic, the communication, the listening skills, the grasping power of concepts, the rapport with coaches and the team mates, the competitiveness, the mental toughness, the athleticism, and hockey intelligence. Further, the points are provided to the athlete 102a are based on his performance. As mentioned above, the ratings and the points are provided by at least one of the athlete 102a and the plurality of stake-holders 112-120. Further, the spider demonstrates the overall ratings of the athlete 102a, the ratings of his skating skills, the puck skills, the hockey sense and the intangibles. FIG. 3E illustrates a sample snapshot of the profile of the athlete 102a, a graph that demonstrates the skating skills of the athlete 102a in months of February and March. Further, the graph is constructed based on a plurality of videos uploaded by the athlete 102a and/or the stake-holders 112-120. Further, FIG. 3E provides the overall rating and the points earned by the athlete 102a. FIG. 3F illustrates the profile of the athlete 102a, graph that demonstrates skating skills of the athlete 102a in months of February and March. Further, the FIG. 3F shows the comment and the rating provided to the athlete 102a by his coach which specifies that the coach is happy with an improving performance of the athlete. Further, the graph is constructed based on a plurality of videos uploaded by the athlete 102a and/or the plurality of stake-holders 112-120. Further, FIG. 3F provides the overall rating, and the points earned by the athlete 102a. FIG. 3G illustrates a sample profile of the coach (head coach). The athlete provides ratings to his coach. The athlete rates the coach based on his hockey knowledge, demeanor, communication skills, team instructions, individual instructions and the preparation level.

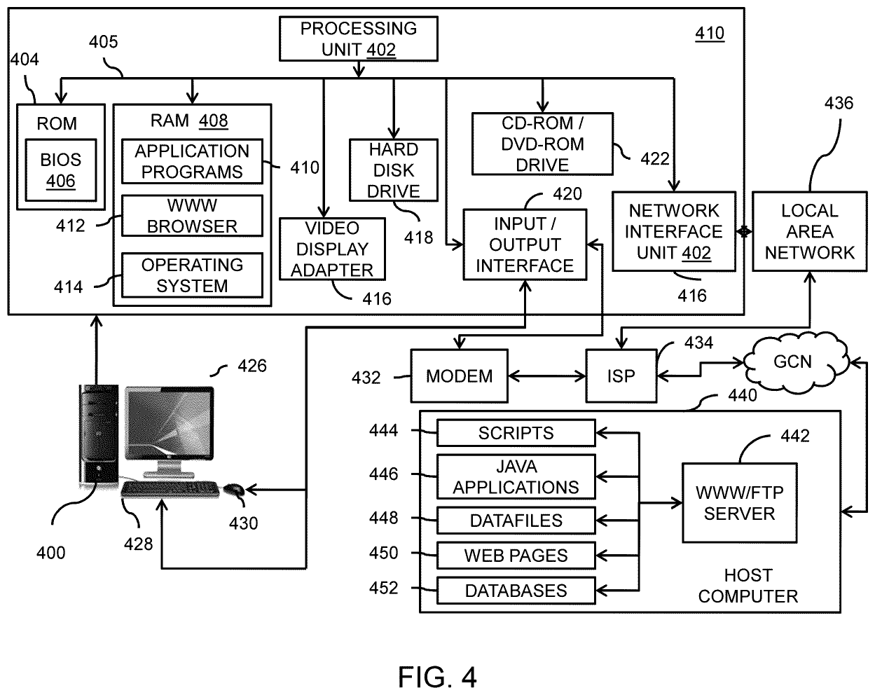

FIG. 4 provides a brief general description of a suitable computing environment in which the disclosure can be implemented. Referring now to FIG. 4, an illustrative environment includes a personal computer 400. The personal computer 400 includes a processing unit 402, a system memory, including read only memory (ROM) 404 and random access memory (RAM) 408, and a system bus 405 that couples the system memory to the processing unit 402. The read only memory (ROM) 404 includes a basic input/output system 406 (BIOS). The basic input/output system 406 contains the basic routines which transfers information between elements within the personal computer 400. Further, the personal computer 400 includes a hard disk drive 418 and an optical disk drive 422. The drives and their associated computer-readable media provide non-volatile storage for the personal computer 400. The non-volatile storage refers to a hard disk, a removable magnetic disk and a CD-ROM or DVD-ROM disk and other similar types of media are readable by a computer. The other type of media storage include magnetic cassettes, flash memory cards, digital video disks, Bernoulli cartridges, and the like. Further, those skilled in the art should appreciate that the personal computer 400 should be broadly interpreted to any machine or device being capable of processing inputs and outputs, calculating results, and in some ways connect to other devices. Examples of the personal computer 400 include but not limited to: personal desktop computers, laptop or notebook, and mobile devices such as iPad, iPhone, Android phone, Android tablet, Blackberry, Blackberry tablet, or any other “smart,” web-enabled cell phones, pocket computers or pocket organizers.

Further, program modules are stored in the drives and RAM 408. The program modules include an operating system 414 and one or more application programs 410. The application programs 410 can be a program for browsing the world-wide-web, such as WWW browser 412.

A user enters commands and information through a keyboard 428 and a pointing device. Examples of the pointing device include but may not be limited to a mouse 430. In addition, the control input devices include a microphone, joystick, game pad, satellite dish, scanner, or the like. These input devices are connected to the processing unit 400 via an input/output interface 420. The input/output interface 420 is coupled to the system bus, but may be connected by other interfaces, such as a game port, universal serial bus, or firewire port.

The personal computer 400 can operate in a networked environment using logical connections to one or more remote computers, such as a host computer 440. Examples of the host computer 440 can be a server, a router, a peer device or other common network node. The networking environments are commonplace in offices, enterprise-wide computer networks, intranets and the GCN.

In general, the host computer 440 includes many or all of the elements of the personal computer 400. The LAN 436 can be connected to a GCN service provider 434 (“ISP”) for access to the GCN 438. In this manner, WWW browser 412 connects to host computer 440 through LAN 436, ISP 434, and the GCN 438. The personal computer 400 is connected to the LAN 436 through a network interface unit 424 when used in a LAN networking environment. The personal computer 400 include a modem 432 or other means for establishing communications through the GCN service provider 434 to the GCN When used in a WAN networking environment. The modem 432 can be internal or external and is connected to the system bus 405 via the input/output interface 420.

In general, the operating system 414 controls the operation of the personal computer 400, including input/output operations. A display monitor 426 or other type of display device is also connected to the system bus 405 via an interface, such as a video display adapter 416. In addition to the monitor, personal computers typically include other peripheral output devices (not shown), such as speakers or printers. The personal computer 400 may be capable of displaying a graphical user interface on monitor 426.

The disclosure can be used in conjunction with Microsoft Corporation's “Windows 98” operating system and a WWW browser 412, such as Microsoft Corporation's GCN EXPLORER, Netscape Corporation's GCN NAVIGATOR, or Mozilla Corporation's GCN FIREFOX, operating under this operating system. Those skilled in the art would appreciate that the disclosure can be implemented for use in other operating systems, such as Microsoft Corporation's “WINDOWS 3.1,” “WINDOWS 95”, “WINDOWS NT”, “WINDOWS 2000”, “WINDOWS XP”, “WINDOWS VISTA”, and “WINDOWS 7” operating systems, IBM Corporation's “OS/2” operating system, SunSoft's “SOLARIS” operating system used in workstations manufactured by Sun Microsystems, and the operating systems used in “MACINTOSH” computers manufactured by Apple Computer, Inc.

In general, the host computer 440 is also connected to the GCN 438, and contains components similar to those contained in personal computer 400. In addition, the host computer 440 can execute an application program for receiving requests for WWW pages, and for serving such pages to the requestor, such as WWW server 442.

The WWW server 442 transmits WWW pages 450 comprising hyper-text markup language (“HTML”) or other markup language files, such as active server pages, to WWW browser 412. Similarly, the WWW server 442 transmits requested data files 448, such as graphical images or text information, to WWW browser 412. The WWW server has the capability to execute scripts 444, such as CGI or PERL scripts, to dynamically produce WWW pages 450 for transmission to WWW browser 412.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, and to thereby enable others skilled in the art to best utilize the present invention and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the present invention.

What is claimed:

1. An athlete data aggregation system comprising (1) a data collection module, in a processor, wherein the data collection module being configured to collect a qualitative and quantitative information corresponding to a plurality of athletes from the plurality of athletes and a plurality of stake-holders, wherein the quantitative and qualitative information comprises sports related information; (2) an analysis engine, in the processor, wherein the analysis engine being configured to analyze the collected quantitative and qualitative information corresponding to the plurality of athletes; (3) an aggregation and visualization engine, in the processor, wherein the aggregation and visualization engine being configured to aggregate and visualize the analyzed qualitative and quantitative information corresponding to the plurality of athletes; and (4) an access control cum distribution engine, in the processor, wherein the access control cum distribution engine being configured to enable a selective distribution of a set of the collected quantitative and qualitative information, the analyzed quantitative and qualitative information, and the aggregated quantitative and qualitative information to each of the plurality of stake-holders.

2. The athlete data aggregation system of claim 1, further comprising a registration module in the processor, wherein the registration module being configured to enable registration of the plurality of athletes and the plurality of stake-holders.

3. The athlete data aggregation system of claim 1, further comprising an update module in the processor, wherein the update module being configured to enable an automatic update of a stored information in a database on encountering an additional information.

4. The athlete data aggregation system of claim 3, wherein the additional information being entered by the plurality of athletes and the plurality of stake-holders.

5. The athlete data aggregation system of claim 1, further comprising a recommendation engine in the processor, wherein the recommendation engine being configured to provide a better opportunities to the plurality of athletes and the plurality of stake-holders.

6. The athlete data aggregation system of claim 1, wherein the sports related information comprises at least one of types of sports played, position in each of the sports played, names of previous and current coaches, names of previous clubs each of the plurality of athletes has represented, names of current clubs each of the plurality of athletes is representing, diet plans, practice plans, levels at which each of the plurality of athletes has played and skills related to the sports played.

7. The athlete data aggregation system of claim 1, wherein the quantitative and qualitative information being visualized by using at least one of mountains, graphs, spiders and pie-charts.

8. The athlete data aggregation system of claim 1, further comprising a database in the processor, wherein the database being configured to store the collected quantitative and qualitative information, the analyzed quantitative and qualitative information, and the aggregated quantitative and qualitative information.

9. The athlete data aggregation system of claim 1, wherein the access control cum distribution engine being further configured to enable each of the plurality of athletes to set a privacy of their respective accounts on a web-based platform.

10. A computer program product comprising a non-transitory computer readable medium storing a computer readable program, wherein the computer readable program when executed on a computer causes the computer to perform steps comprising (1) collecting a qualitative and quantitative information corresponding to a plurality of athletes from the plurality of athletes and a plurality of stake-holders, wherein the qualitative and quantitative information comprises sports related information; (2) analyzing the collected qualitative and quantitative information corresponding to the plurality of athletes; (3) aggregating and visualizing the analyzed qualitative and quantitative information corresponding to the plurality of athletes; and (4) selectively distributing a set of the collected quantitative and qualitative information, the analyzed quantitative and qualitative information, and the aggregated quantitative and qualitative information to each of the plurality of stake-holders.

11. The computer program product of claim 10, wherein the computer readable program when executed on the computer causes the computer to perform a further step of enabling registration of the plurality of athletes and the plurality of stake-holders.

12. The computer program product of claim 10, wherein the computer readable program when executed on the computer causes the computer to perform a further step of enabling an automatic update of stored information in a database on encountering an additional information.

13. The computer program product of claim 10, wherein the computer readable program when executed on the computer causes the computer to perform a further step of providing better opportunities to the plurality of athletes and the plurality of stake-holders.

14. The computer program product of claim 10, wherein the computer readable program when executed on the computer causes the computer to perform a further step of storing the collected quantitative and qualitative information, the analyzed quantitative and qualitative information, and the aggregated quantitative and qualitative information.

15. The computer program product of claim 10, wherein the computer readable program when executed on the computer causes the computer to perform a further step of enabling each of the plurality of athletes to set a privacy of their respective accounts on a web-based platform.

16. The computer program product of claim 10, wherein the computer readable program when executed on the computer causes the computer to perform a further step of enabling the plurality of stake-holders to provide specific comments and suggestions to the plurality of athletes.

17. The computer program product of claim 10, wherein the plurality of stake-holders comprises at least one of a plurality of coaches, a plurality of club managers, a plurality of governing bodies, a plurality of scouts and guardians.

18. The computer program product of claim 10, wherein the computer readable program when executed on the computer causes the computer to perform a further step of providing a chance to the plurality of athletes to earn profits based on their ratings.

19. The computer program product of claim 10, wherein the computer readable program when executed on the computer causes the computer to perform a further step of providing a feedback to the plurality of athletes and the associated stake-holders.

20. The computer program product of claim 10, wherein the computer readable program when executed on the computer causes the computer to perform a further step of providing parameters for measuring strengths, weakness and progress of each of the plurality of athletes and the plurality of stake-holders.
